(19) United States
(12) Patent Application Publication
(10) Pub. No.: US 2023/0244748 A1
(43) Pub. Date: Aug. 3, 2023

(54) Matrix Multiplication on Coarse-grained Computing Grids

(71) Applicant: SambaNova Systems, Inc., Palo Alto, CA (US)

(72) Inventors: Pramod Natarja, San Jose, CA (US); Sitanshu Gupta, San Jose, CA (US); Ram Sivaramakrishnan, San Jose, CA (US); Ajit Punj, San Jose, CA (US)

(73) Assignee: SambaNova Systems, Inc., Palo Alto, CA (US)

(21) Appl. No.: 17/824,830

(22) Filed: May 25, 2022

Related U.S. Application Data
(60) Provisional application No. 63/305,647, filed on Feb. 1, 2022.

(51) Int. Cl. G06F 17/16

(52) U.S. Cl. CPC G06F 17/16

(57) ABSTRACT

A method for multiplying matrices in a coarse-grained computing grid includes assigning each compute unit c of C compute units to a unique submatrix R_{c} of a result matrix R, wherein the C compute units are arranged in a 2D computing grid, configuring one or more source memory units to provide relevant matrix A data and matrix B data to the C compute units via a plurality of packets, configuring each compute unit c to produce the unique submatrix R_{c} and send the unique submatrix R_{c} to one or more desired memory units. The method also includes initiating data flow in the computing grid to produce the result matrix R within the desired memory units. To reduce packet traffic, Matrix B data corresponding to a column of compute units may be narrow-casted to each column of compute units. A corresponding system and computer-readable medium are also disclosed herein.

### RELATED APPLICATIONS AND DOCUMENTS

This application claims the benefit of (priority to) U.S. Provisional Application 63/305,647 filed on Feb. 1, 2022 entitled “Matrix Multiplication on Coarse-grained Computing Grids,” (Attorney Docket No. SBNV 1052-1).

This application is related to the following papers and commonly owned applications:
U.S. Nonprovisional patent application Ser. No. 16/260,548, filed Jan. 29, 2019, entitled “MATRIX NORMAL/TRANSPOSE READ AND A RECONFIGURABLE DATA PROCESSOR INCLUDING SAME,” (Attorney Docket No. SBNV 1005-1);
U.S. Nonprovisional patent application Ser. No. 15/930,381, filed May 12, 2020, entitled “COMPUTATIONALLY EFFICIENT GENERAL MATRIX-MATRIX MULTIPLICATION (GEMM),” (Attorney Docket No. SBNV 1019-1);
U.S. Nonprovisional patent application Ser. No. 16/890,841, filed Jun. 2, 2020, entitled “ANTI-CONGESTION FLOW CONTROL FOR RECONFIGURABLE PROCESSORS,” (Attorney Docket No. SBNV 1021-1);
U.S. Nonprovisional patent application Ser. No. 17/216,647, filed Mar. 29, 2021, entitled “TENSOR PARTITIONING AND PARTITION ACCESS ORDER,” (Attorney Docket No. SBNV 1031-1);
U.S. Provisional Patent Application No. 63/190,749, filed May 19, 2021, entitled “FLOATING POINT MULTIPLY-ADD, ACCUMULATE UNIT WITH CARRY-SAVE ACCUMULATOR,” (Attorney Docket No. SBNV 1037-6);
U.S. Provisional Patent Application No. 63/174,460, filed Apr. 13, 2021, entitled “EXCEPTION PROCESSING IN CARRY-SAVE ACCUMULATION UNIT FOR MACHINE LEARNING,” (Attorney Docket No. SBNV 1037-7);
U.S. Nonprovisional patent application Ser. No. 17/397,241, filed Aug. 9, 2021, entitled “FLOATING POINT MULTIPLY-ADD, ACCUMULATE UNIT WITH CARRY-SAVE ACCUMULATOR.” (Attorney Docket No. SBNV 1037-9);
U.S. Nonprovisional patent application Ser. No. 17/520,290, filed Nov. 5, 2021, entitled “SPARSE MATRIX MULTIPLIER IN HARDWARE AND A RECONFIGURABLE DATA PROCESSOR INCLUDING SAME,” (Attorney Docket No. SBNV 1046-2);

All of the related application(s) and documents listed above are hereby incorporated by reference herein for all purposes.

### BACKGROUND

The present subject matter relates to conducting matrix multiplication in a reconfigurable coarse-grained grid computing architecture.

Reconfigurable processors, including field programmable gate arrays FPGAs, can be configured to implement a variety of functions more efficiently or faster than might be achieved using a general purpose processor executing a computer program. So called coarse-grain reconfigurable architectures (e.g. CGRAs) are being developed in which the configurable units in the array are more complex than used in typical, more fine-grained FPGAs, and may enable faster or more efficient execution of various classes of functions. For example, CGRAs have been proposed that can enable implementation of energy-efficient accelerators for machine learning and artificial intelligence workloads. See, Prabhakar, et al., “Plasticine: A Reconfigurable Architecture for Parallel Patterns,” ISCA '17, Jun. 24-28, 2017, Toronto, ON, Canada.

With the rapid expansion of applications that can be characterized by dataflow processing, such as natural-language processing and recommendation engines, the performance and efficiency challenges of traditional, instruction set architectures have become apparent. First, the sizable, generation-to-generation performance gains for multicore processors have tapered off. As a result, developers can no longer depend on traditional performance improvements to power more complex and sophisticated applications. This holds true for both CPU fat-core and GPU thin-core architectures. A new approach is required to extract more useful work from current semiconductor technologies. Amplifying the gap between required and available computing is the explosion in the use of deep learning. According to a study by OpenAI, during the period between 2012 and 2020, the compute power used for notable artificial intelligence achievements has doubled every 3.4 months. It is common for GPUs to be used for training and CPUs to be used for inference in machine learning systems based on their different characteristics. Many real-life systems demonstrate continual and sometimes unpredictable change, which means predictive accuracy of models declines without frequent updates.

Finally, while the performance challenges are acute for machine learning, other workloads such as analytics, scientific applications and even SQL data processing all could benefit from dataflow processing. New approaches should be flexible enough to support broader workloads and facilitate the convergence of machine learning and high-performance computing or machine learning and business applications.

### SUMMARY OF THE INVENTION

A method for multiplying matrices in a coarse-grained computing grid includes assigning each compute unit c of C compute units to a unique submatrix R_{c} of a result matrix R, wherein the C compute units are arranged in a 2D grid comprising m logical rows and n logical columns, configuring one or more source memory units to provide relevant matrix A data and matrix B data to the C compute units via a plurality of packets, configuring each compute unit c to produce the unique submatrix R_{c} and send the unique submatrix R_{c} to one or more desired memory units. The method also includes initiating data flow in the computing grid to produce the result matrix R within the desired memory units. Providing matrix B data to the C compute units may include narrowcasting packets to each column of compute units in the 2D computing grid, the narrow-casted packets comprising matrix B data corresponding to the column of compute units. A corresponding system and computer-readable medium are also disclosed herein.

### BRIEF DESCRIPTION OF THE DRAWINGS

FIG. 1A is a layout diagram illustrating a CGRA (Coarse-Grained Reconfigurable Architecture) suitable for dataflow computing.

FIG. 1B is a block diagram of a compiler stack suitable for a CGRA (Coarse-Grained Reconfigurable Architecture).

FIG. 1C is a system diagram illustrating a system including a host, a memory, and a reconfigurable data processor.

FIG. 2 is a simplified block diagram of a top-level network and components of a CGRA (Coarse Grain Reconfigurable Architecture).

FIG. 3A is a simplified diagram of a tile and an array level network usable in the configuration of FIG. 2, where the configurable units are nodes on the array level network.

FIG. 3B illustrates an example switch unit connecting elements in an array level network.

FIG. 4 is a block diagram illustrating an example configurable unit, such as a Pattern Compute Unit (PCU).

FIG. 5 is a block diagram illustrating another example of a configurable unit, such as a Pattern Memory Unit (PMU).

FIG. 6A shows one example of matrix partitioning in accordance with the matrix multiplication methods disclosed herein.

FIG. 6B shows pseudo code for one example of submatrix multiplication suitable for a grid computing environment.

FIG. 6C is a block diagram illustrating one example of a matrix multiplication system in accordance with the matrix multiplication methods disclosed herein.

FIG. 7A is a flowchart of one example of a matrix multiplication invocation method suitable for a reconfigurable grid computing environment.

FIG. 7B is a flowchart of one example of a submatrix multiplication execution method suitable for a reconfigurable grid computing environment.

FIG. 8A shows one example of distributing matrices in an example grid computing environment.

FIG. 8B is a block diagram illustrating one example of a compute unit configurable for the matrix multiplications methods disclosed herein.

FIG. 9A and FIG. 9B show one example of uniform partitioning of matrices used in matrix multiplication.

FIG. 10A and FIG. 10B show one example of residual partitioning of matrices used in matrix multiplication.

FIG. 11 and FIG. 12 show one example of fractional partitioning of matrices used in matrix multiplication.

### DETAILED DESCRIPTION

The following detailed description is made with reference to the figures. Example implementations are described to illustrate the technology disclosed, not to limit its scope, which is defined by the claims. Those of ordinary skill in the art will recognize a variety of equivalent variations on the description that follows.

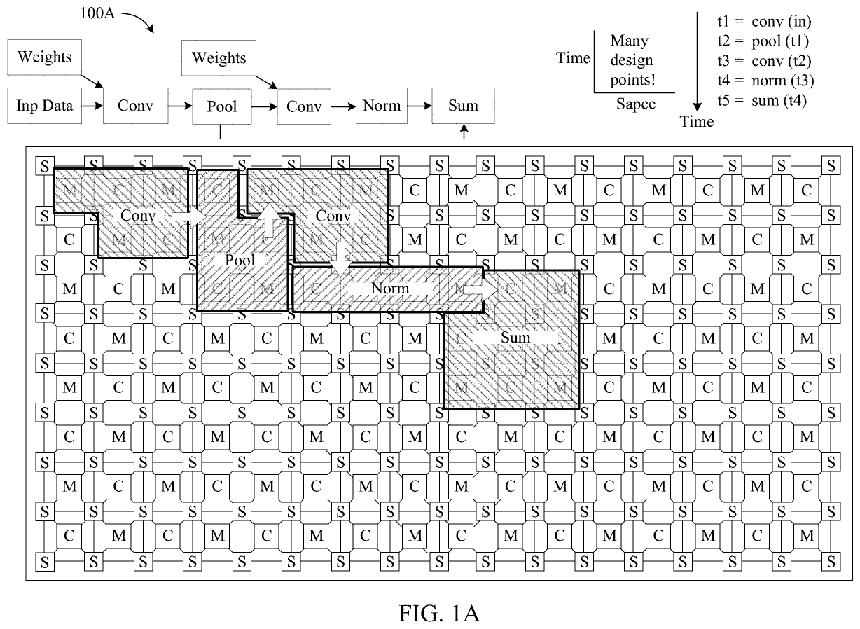

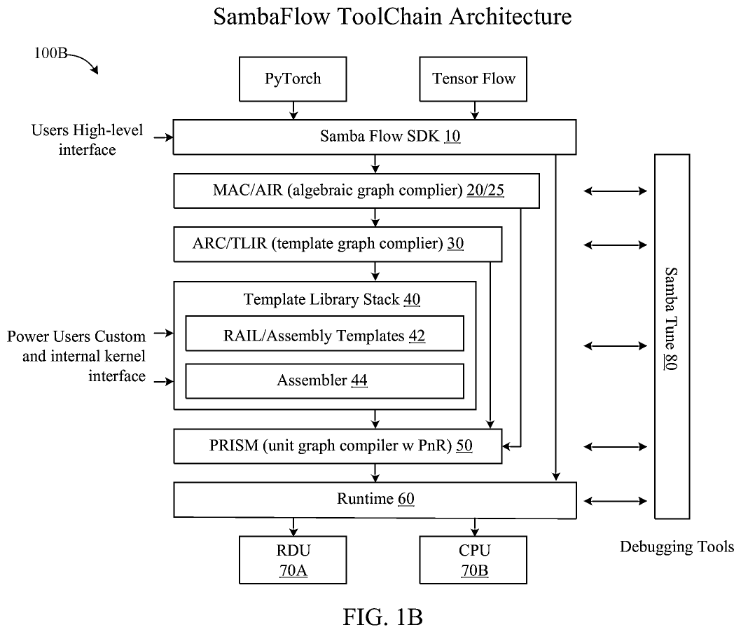

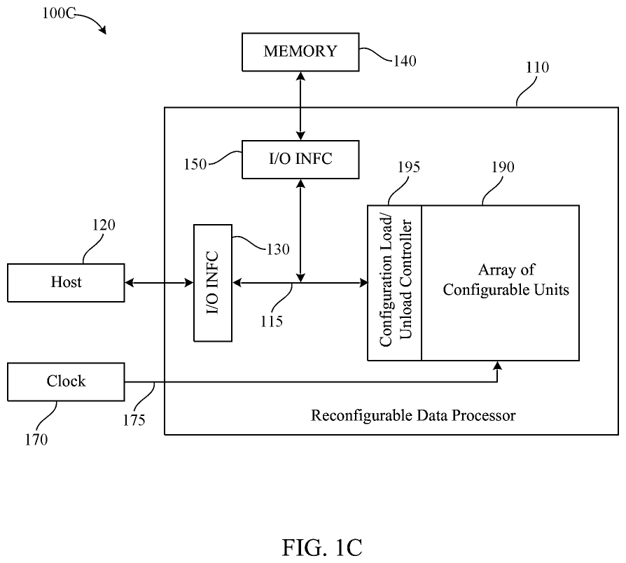

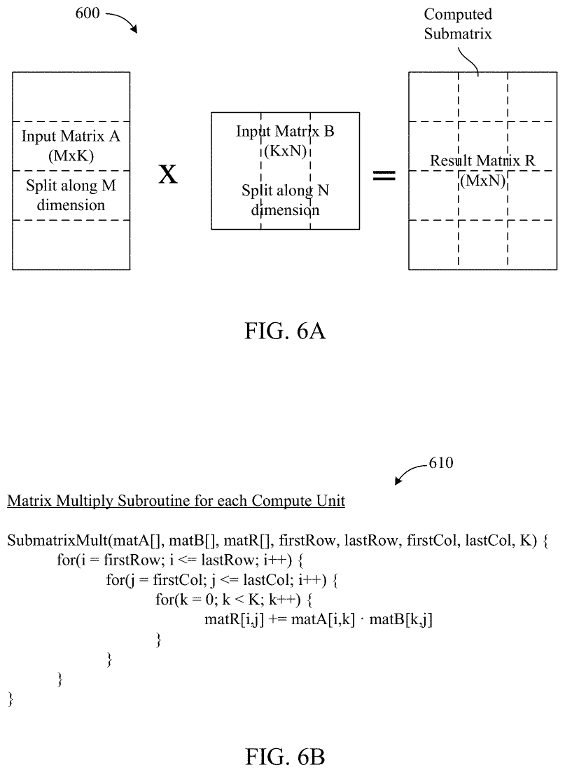

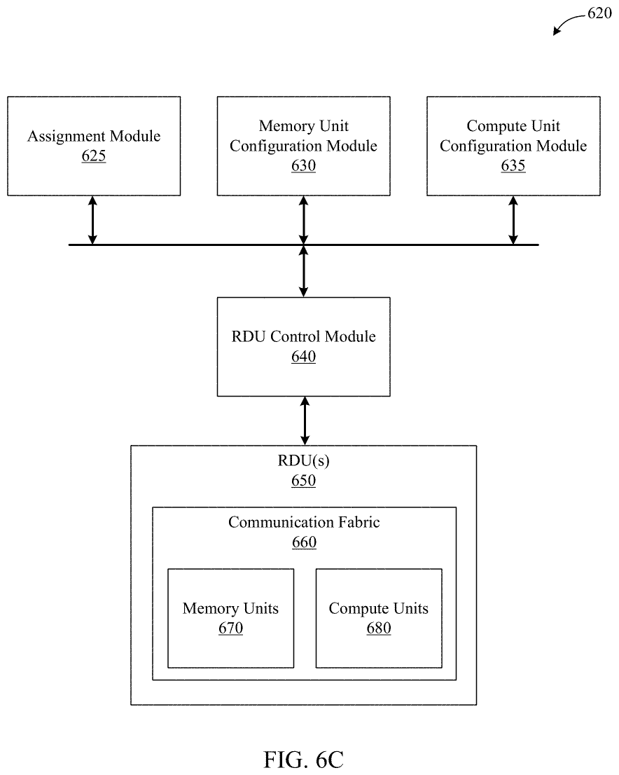

FIGS. 1-5 depict at least one example of an environment wherein the present invention may be deployed while FIGS. 6-12 depict details on various embodiments of the present invention.

Referring now to FIGS. 1A and 1B, FIG. 1A is a layout diagram illustrating a CGRA (Coarse Grain Reconfigurable Architecture) 100A suitable for dataflow computing. The depicted CGRA comprises compute units and memory units interleaved into a computing grid. The compute units and memory units as well as address generation units (not shown in FIG. 1) may be reconfigurable units that support dataflow computing. One or more instances of the depicted CGRA computing grid along with some external communication ports (not shown) may be integrated into a computational unit referred to as an RDU (Reconfigurable Dataflow Unit).

The architecture, configurability and dataflow capabilities of the CGRA enables increased computing power that supports both parallel and pipelined computation. Consequently, the CGRA represents a computing paradigm shift that provides unprecedented processing power and flexibility. Leveraging the parallel, pipelined and reconfigurable aspects of the CGRA adds new dimensions of complexity that requires a fundamentally new instruction compilation process and software stack.

While traditional compilers sequentially map operations to processor instructions, typically without regard to pipeline utilization and duration (a task usually handled by the hardware), the course-grained reconfigurable computing grid requires mapping operations to processor instructions in both time and space. Furthermore, while communication through the memory hierarchy of traditional (e.g., von Neumann) computers is implicitly sequential and handled by hardware, dataflow compilers map both sequential (including pipelined) operations and parallel operations to instructions in time and in space and also program the communication between the compute units and memory units.

The depicted example, which illustrates typical machine learning operations on images, includes two stages of convolution operations that are augmented with a pooling stage, a normalization stage, and a summing stage. One of skill in the art will appreciate that the depicted stages may be used as a highly efficient pipeline if the throughputs of the stages are appropriately matched. One of skill in the art will also appreciate that other operations and tasks may be executing in parallel to the depicted operations and that the allocation of resources must be spatially and temporally coordinated. Consequently, compiler (and optionally programmer) assignment of compute and memory resources to the various stages of processing (both spatially and temporally) has a direct effect on resource utilization and system performance.

FIG. 1B is a block diagram of a compiler stack 100B suitable for a CGRA (Coarse Grain Reconfigurable Architecture). As depicted, the compiler stack 100B includes a number of stages or levels that convert high-level algorithmic expressions and functions (e.g., PyTorch and TensorFlow expressions and functions) to configuration instructions for the reconfigurable units of the CGRA.

The SambaFlow SDK 10 converts user selected and configured algorithms and functions from high-level libraries such as PyTorch and TensorFlow to computational graphs. The nodes of the computational graphs are intrinsically parallel unless a dependency is indicated by an edge in the graph.

The MAC (Model Analyzer and Compiler) level 20 makes high-level mapping decisions for (sub-graphs of the) computational graphs based on hardware constraints. The depicted embodiment supports various application frontends such as Samba, JAX, and TensorFlow/HLO. The MAC may also transform the graphs via autodiff and GradNorm, perform stitching between sub-graphs, interface with template generators for performance/latency estimation, convert Samba operations to AIR (Arithmetic/Algebraic Intermediate Representation) operations, perform tiling, sharding and section cuts and model/estimate the parallelism that can be achieved on the computational graphs.

The AIR level 25 translates high-level graph and mapping decisions provided by the MAC level into explicit TLIR (Template Library Intermediate Representation) graphs. The key responsibilities of the AIR level 25 include legalizing the graph and mapping decisions of the MAC, expanding data parallel, tiling, metapipe, region, and hypersection instructions provided by the MAC, converting AIR operations to TLIR operations, inserting stage buffers and skip buffers, eliminating redundant operations, buffers and sections and optimizing for resource use, latency, and throughput.

The ARC level 30 translates mid-level (e.g., TLIR) graphs provided by AIR into Prism source code optimizing for the target hardware architecture and legalizes the dataflow graph through each performed step. The translating is accomplished by converting IR (intermediate representation) operations to appropriate Prism/RAIL (RDU Abstract Intermediate Language) templates, stitching templates together with data-flow and control-flow, inserting necessary buffers and layout transforms, generating test data and optimizing for resource use, latency, and throughput.

The template library stack 40 provides a library of templates 42. The templates 42 are containers for common operations. Templates may be implemented using Assembly or RAIL. While RAIL is similar to Assembly in that memory units and compute units are separately programmed, RAIL provides a higher level of abstraction and compiler intelligence via a concise performance-oriented DSL (Domain Specific Language) for RDU templates. RAIL enables template writers and external power users to control the interactions between the logical compute units and memory units with high-level expressions without the need to manually program capacity splitting, register allocation, etc. The logical compute units and memory units also enable stage/register allocation, context splitting, transpose slotting, resource virtualization and mapping to multiple physical compute units and memory units (e.g., PCUs and PMUs). RAIL also enables event handle allocation.

The Assembler level 44 provides an architecture agnostic low-level programming model as well as optimization and code generation for the target hardware architecture. Responsibilities of the Assembler include address expression compilation, intra-unit resource allocation and management, legalization with target-specific rules, low-level architecture-specific transformations and optimizations, and architecture-specific code generation.

The Prism layer 50 translates ARC template graphs to a physical chip mapping, generates code for the target hardware architecture, legalizes and lowers dataflow graphs to the physical network (e.g., PCUs, PMUs and switches) and produces PEF (Processor Executable Format) files. The Prism layer 50 also conducts PNR (Place and Route) by generating bandwidth calculations, determining the placement of PMUs and PCUs, allocating AGCUs (address generation control units) and VAGs (Virtual Address Generators), selecting PCM/PCU ports and generating configuration information for compute grid switches to enable data routing.

The runtime layer 60 controls execution of the physical level dataflow graphs on actual hardware such the RDU 70A and/or CPU 70B. SambaTune 80 is a set of debugging tools that can facilitate users to perform deadlock and performance debugging on the RDU chip. SambaTune 80 can summarize and visualize instrumentation counters from the RDU that can guide users to identify performance bottlenecks and eliminate by tuning various control parameters.

### Array Level Network (ALN)—A Flexible Network for Dataflow Processing

Referring now to FIG. 1C through FIG. 5 generally, a tile of an embodiment of a coarse-grain reconfigurable architecture (CGRA) is based on an array of fused compute-memory units (FCMUs), pattern memory units (PMUs), and/or pattern compute units (PCUs) arranged in two dimensions, M×N. Unless clearly noted from context, any reference to a FCMU, PCU, or PMU may refer to one or more of the other units. The communication between a set of FCMUs is performed over a (M+1)×(N+1) switch fabric called the array-level network (ALN) where each switch has connections to its neighboring FCMUs and to neighboring switches in each of the four directions.

The ALN includes three physical networks—Vector, Scalar and Control. The vector network and scalar networks are packet switched whereas the control network is circuit switched. Each vector packet consists of a vector payload and a header that includes information such as the packet's destination, sequence ID, virtual channel (aka flow control class) etc. Each scalar packet contains a word (32-bits) of payload and a header containing the packet's destination and the packet's type. The Control network consists of a bunch of single bit wires where each wire is pulsed to transmit a specific control token providing distributed control to orchestrate the execution of a program across multiple FMCUs. The scalar network can also be used to carry control information by overloading a scalar packet using its packet type field.

Parallel Applications such as Machine Learning, Analytics, and Scientific Computing require different types of communication between the parallel compute units and the distributed or shared memory entities. These types of communication can be broadly classified as point-to-point, one-to-many, many-to-one and many-to-many. The ALN enables these communication types through a combination of routing, packet sequence ID and flow control.

Routing of packets on the vector and scalar networks is done using two mechanisms—2D Dimension Order Routing (DOR) or using a software override using Flows. Flows can be used for multiple purposes such as to perform overlap-free routing of certain communications and to perform a multicast from one source to multiple destinations without having to resend the same packet, once for each destination.

Sequence ID based transmissions allow the destination of a many-to-one communication to reconstruct the dataflow order without having to impose restrictions on the producer/s. The packet switched network provides two flow control classes—end to end flow controlled and locally flow controlled. The former class of packet, VC_B, is released by a producer only after ascertaining that the consumer has space for it. The latter class of packet, VC_A, is loosely flow controlled and released into the network without knowing if the receiver has space for it. VC_A packets are used for performance critical communication where a non-overlapping route can be provided between the producer and consumer.

The core component of the ALN is the ALN switch. A packet or control pulse enters the ALN through an interface between the producing FCMU(X) and one of its adjacent switches. While in the ALN, the packet/pulse takes some number of hops until it reaches a switch adjacent to the consumer FCMU (Y). Finally, it takes the interface to Y to complete the route.

When a packet reaches a switch's input port, it is first inspected to see if it should be dimension order routed or flow routed. If it is the former, the destination ID is mapped to a unique output port. If it is the latter, the flow ID of the incoming packet is used to index into a table that identifies the output ports to route the packet to.

Packets from the two different flow control classes, VC_A and VC_B, are managed differently at the source port of every switch. Since VC_B packets are end-to-end flow controlled, they are always allowed to make forward progress through it regardless of the blocking conditions on VC_A packets.

FIG. 1C is a system diagram illustrating a system 100C including a host 120, a memory 140, and a reconfigurable data processor 110. As shown in the example of FIG. 1C, the reconfigurable data processor 110 includes an array 190 of configurable units and a configuration load/unload controller 195. The phrase “configuration load/unload controller”, as used herein, refers to a combination of a configuration load controller and a configuration unload controller. The configuration load controller and the configuration unload controller may be implemented using separate logic and data path resources or may be implemented using shared logic and data path resources as suits a particular embodiment. In some embodiments, a system may include only a configuration load controller of the types described herein. In some embodiments, a system may include only a configuration unload controller of the types described herein.

The processor 110 includes an external I/O interface 130 connected to the host 120, and external I/O interface 150 connected to the memory 140. The I/O interfaces 130, 150 connect via a bus system 115 to the array 190 of configurable units and to the configuration load/unload controller 195. The bus system 115 may have a bus width that carries one chunk of data, which can be for this example 128 bits (references to 128 bits throughout can be considered as an example chunk size more generally). In general, a chunk of the configuration file can have N bits of data, and the bus system can be configured to transfer N bits of data in one bus cycle, where N is any practical bus width. A sub-file distributed in the distribution sequence can consist of one chunk, or other amounts of data as suits a particular embodiment. Procedures are described herein using sub-files consisting of one chunk of data each. Of course, the technology can be configured to distribute sub-files of different sizes, including sub-files that may consist of two chunks distributed in two bus cycles for example.

To configure configurable units in the array 190 of configurable units with a configuration file, the host 120 can send the configuration file to the memory 140 via the interface 130, the bus system 115, and the interface 150 in the reconfigurable data processor 110. The configuration file can be loaded in many ways, as suits a particular architecture, including in data paths outside the configurable processor 110. The configuration file can be retrieved from the memory 140 via the memory interface 150. Chunks of the configuration file can then be sent in a distribution sequence as described herein to configurable units in the array 190 of configurable units in the reconfigurable data processor 110.

An external clock generator 170 or other clock signal sources can provide a clock signal 175 or clock signals to elements in the reconfigurable data processor 110, including the array 190 of configurable units, and the bus system 115, and the external data I/O interfaces 130 and 150.

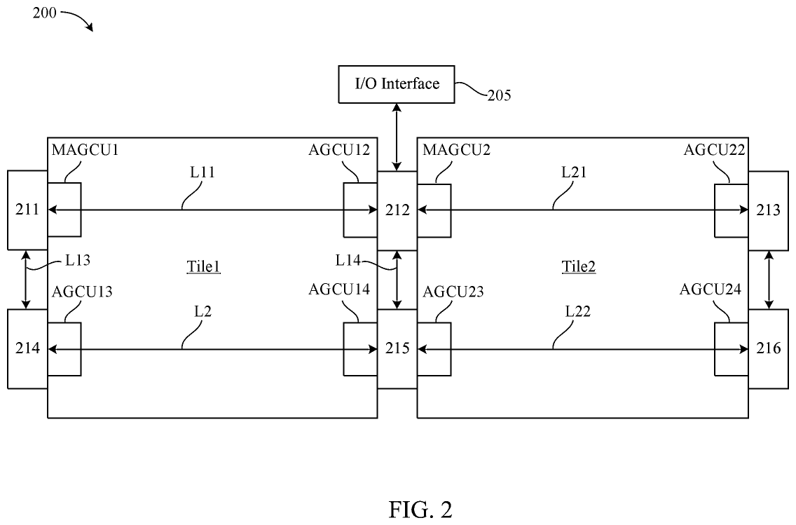

FIG. 2 is a simplified block diagram of components of a CGRA (Coarse Grain Reconfigurable Architecture) processor 200. In this example, the CGRA processor 200 has 2 tiles (Tile1, Tile2). Each tile comprises an array of configurable units connected to a bus system, including an array level network (ALN) in this example. The bus system includes a top-level network connecting the tiles to external I/O interface 205 (or any number of interfaces). In other embodiments, different bus system configurations may be utilized. The configurable units in each tile are nodes on the ALN in this embodiment.

In the depicted embodiment, each of the two tiles has 4 AGCUs (Address Generation and Coalescing Units) (e.g. MAGCU1, AGCU12, AGCU13, AGCU14). The AGCUs are nodes on the top-level network and nodes on the ALNs and include resources for routing data among nodes on the top-level network and nodes on the ALN in each tile.

Nodes on the top-level network in this example include one or more external I/O, including interface 205. The interfaces to external devices include resources for routing data among nodes on the top-level network and external devices, such as high-capacity memory, host processors, other CGRA processors, FPGA devices and so on, that are connected to the interfaces.

One of the AGCUs in a tile is configured in this example to be a master AGCU, which includes an array configuration load/unload controller for the tile. In other embodiments, more than one array configuration load/unload controller can be implemented, and one array configuration load/unload controller may be implemented by logic distributed among more than one AGCU.

The MAGCU1 includes a configuration load/unload controller for Tile1, and MAGCU2 includes a configuration load/unload controller for Tile2. In other embodiments, a configuration load/unload controller can be designed for loading and unloading configuration of more than one tile. In other embodiments, more than one configuration controller can be designed for configuration of a single tile. Also, the configuration load/unload controller can be implemented in other portions of the system, including as a stand-alone node on the top-level network and the ALN or networks.

The top-level network is constructed using top-level switches (211-216) connecting to each other as well as to other nodes on the top-level network, including the AGCUs, and I/O interface 205. The top-level network includes links (e.g. L11, L12, L21, L22) connecting the top-level switches. Data travel in packets between the top-level switches on the links, and from the switches to the nodes on the network connected to the switches. For example, top-level switches 211 and 212 are connected by a link L11, top-level switches 214 and 215 are connected by a link L12, top-level switches 211 and 214 are connected by a link L13, and top-level switches 212 and 213 are connected by a link L21. The links can include one or more buses and supporting control lines, including for example a chunk-wide bus (vector bus). For example, the top-level network can include data, request, and response channels operable in coordination for transfer of data in a manner analogous to an AXI compatible protocol. See, AMBA® AXI and ACE Protocol Specification, ARM, 2017.

Top-level switches can be connected to AGCUs. For example, top-level switches 211, 212, 214 and 215 are connected to MAGCU1, AGCU12, AGCU13 and AGCU14 in the tile Tile1, respectively. Top-level switches 212, 213, 215 and 216 are connected to MAGCU2, AGCU22, AGCU23 and AGCU24 in the tile Tile2, respectively. Top-level switches can be connected one or more external I/O interfaces (e.g. interface 205).

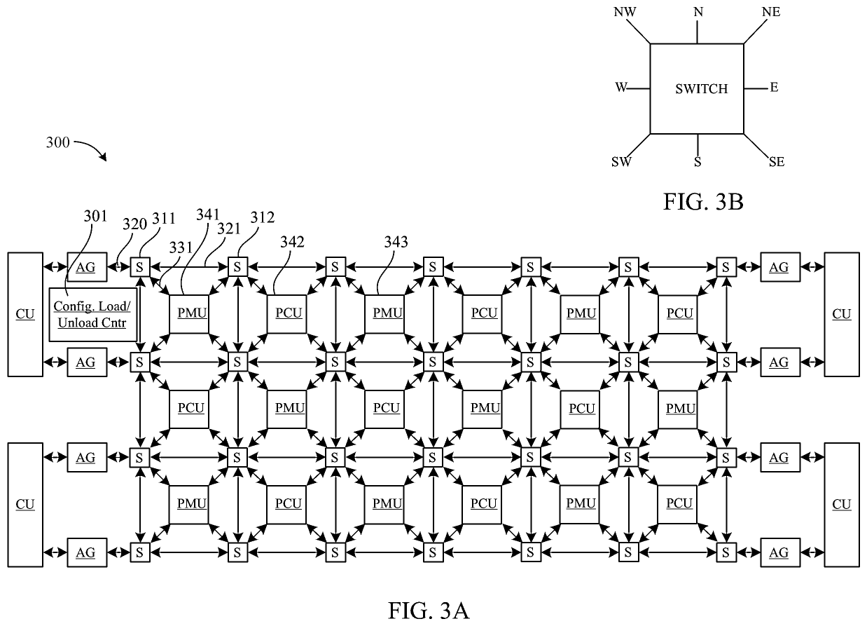

FIG. 3A is a simplified diagram of a tile and an ALN usable in the configuration of FIG. 2, where the configurable units in the array are nodes on the ALN. In this example, the array of configurable units 300 includes a plurality of types of configurable units. The types of configurable units in this example, include Pattern Compute Units (PCU), Pattern Memory Units (PMU), switch units (S), and Address Generation and Coalescing Units (each including two address generators AG and a shared CU). For an example of the functions of these types of configurable units, see, Prabhakar et al., “Plasticine: A Reconfigurable Architecture For Parallel Patterns”, ISCA '17, Jun. 24-28, 2017, Toronto, ON, Canada, which is incorporated by reference as if fully set forth herein. Each of these configurable units contains a configuration store comprising a set of registers or flip-flops that represent either the setup or the sequence to run a program, and can include the number of nested loops, the limits of each loop iterator, the instructions to be executed for each stage, the source of the operands, and the network parameters for the input and output interfaces.

Additionally, each of these configurable units contains a configuration store comprising a set of registers or flip-flops that store status usable to track progress in nested loops or otherwise. A configuration file contains a bit-stream representing the initial configuration, or starting state, of each of the components that execute the program. This bit-stream is referred to as a bit-file. Program load is the process of setting up the configuration stores in the array of configurable units based on the contents of the bit file to allow all the components to execute a program (i.e., a machine). Program Load may also require the load of all PMU memories.

The ALN includes links interconnecting configurable units in the array. The links in the ALN include one or more and, in this case three, kinds of physical buses: a chunk-level vector bus (e.g. 128 bits of data), a word-level scalar bus (e.g. 32 bits of data), and a multiple bit-level control bus. For instance, interconnect 321 between switch units 311 and 312 includes a vector bus interconnect with vector bus width of 128 bits, a scalar bus interconnect with a scalar bus width of 32 bits, and a control bus interconnect.

The three kinds of physical buses differ in the granularity of data being transferred. In one embodiment, the vector bus can carry a chunk that includes 16-Bytes (=128 bits) of data as its payload. The scalar bus can have a 32-bit payload and carry scalar operands or control information. The control bus can carry control handshakes such as tokens and other signals. The vector and scalar buses can be packet switched, including headers that indicate a destination of each packet and other information such as sequence numbers that can be used to reassemble a file when the packets are received out of order. Each packet header can contain a destination identifier that identifies the geographical coordinates of the destination switch unit (e.g. the row and column in the array), and an interface identifier that identifies the interface on the destination switch (e.g. North, South, East, West, etc.) used to reach the destination unit. The control network can be circuit switched based on timing circuits in the device, for example. The configuration load/unload controller can generate a header for each chunk of configuration data of 128 bits. The header is transmitted on a header bus to each configurable unit in the array of configurable unit.

In one example, a chunk of data of 128 bits is transmitted on the vector bus that provides the chunk as vector inputs to a configurable unit. The vector bus can include 128 payload lines, and a set of header lines. The header can include a sequence ID for each chunk, which can include:
A bit to indicate if the chunk is scratchpad memory or configuration store data.
Bits that form a chunk number.
Bits that indicate a column identifier.
Bits that indicate a row identifier.
Bits that indicate a component identifier.

For a load operation, the configuration load controller can send N chunks to a configurable unit in order from N−1 to 0. For this example, the 6 chunks are sent out in most significant bit first order of Chunk 5->Chunk 4->Chunk 3->Chunk 2->Chunk 1->Chunk 0. (Note that this most significant bit first order results in Chunk 5 being distributed in round 0 of the distribution sequence from the array configuration load controller.) For an unload operation, the configuration unload controller can write out the unload data of order to the memory. For both load and unload operations, the shifting in the configuration serial chains in a configuration data store in a configurable unit is from LSB (least-significant-bit) to MSB (most-significant-bit), or MSB out first.

FIG. 3B illustrates an example switch unit connecting elements in an ALN. As shown in the example of FIG. 3B, a switch unit can have 8 interfaces. The North, South, East and West interfaces of a switch unit are used for connections between switch units. The Northeast, Southeast, Northwest and Southwest interfaces of a switch unit are each used to make connections to PCU or PMU instances. A set of 2 switch units in each tile quadrant have connections to an Address Generation and Coalescing Unit (AGCU) that include multiple address generation (AG) units and a coalescing unit (CU) connected to the multiple address generation units. The coalescing unit (CU) arbitrates between the AGs and processes memory requests. Each of the 8 interfaces of a switch unit can include a vector interface, a scalar interface, and a control interface to communicate with the vector network, the scalar network, and the control network.

During execution of a machine after configuration, data can be sent via one or more unit switches and one or more links between the unit switches to the configurable units using the vector bus and vector interface(s) of the one or more switch units on the ALN.

In embodiments described herein, a configuration file or bit file, before configuration of the tile, can be sent from the configuration load controller using the same vector bus, via one or more unit switches and one or more links between the unit switches to the configurable unit using the vector bus and vector interface(s) of the one or more switch units on the ALN. For instance, a chunk of configuration data in a unit file particular to a configurable unit PMU 341 can be sent from the configuration load/unload controller 301 to the PMU 341, via a link 320 between the configuration load/unload controller 301 and the West (W) vector interface of the switch unit 311, the switch unit 311, and a link 331 between the Southeast (SE) vector interface of the switch unit 311 and the PMU 341.

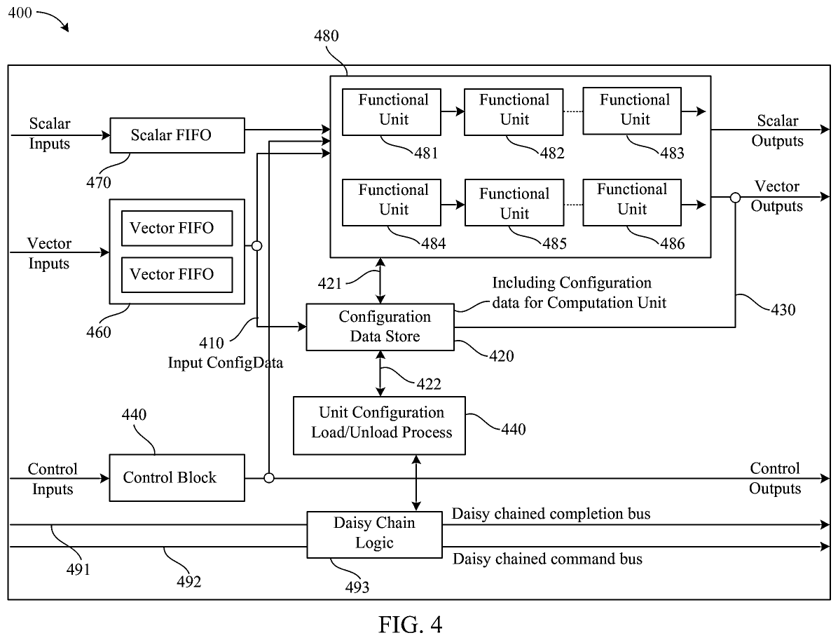

In this example, one of the AGCUs is configured to be a master AGCU, which includes a configuration load/unload controller (e.g. 301). The master AGCU implements a register through which the host (120, FIG. 1) can send commands via the bus system to the master AGCU. The master AGCU controls operations on an array of configurable units in a tile and implements a program control state machine to track the state of the tile based on the commands it receives from the host through writes to the register. For every state transition, the master AGCU issues commands to all components on the tile over a daisy chained command bus (FIG. 4). The commands include a program reset command to reset configurable units in an array of configurable units in a tile, and a program load command to load a configuration file to the configurable units.

The configuration load controller in the master AGCU is responsible for reading the configuration file from the memory and sending the configuration data to every configurable unit of the tile. The master AGCU can read the configuration file from the memory at preferably the maximum throughput of the top-level network. The data read from memory are transmitted by the master AGCU over the vector interface on the ALN to the corresponding configurable unit according to a distribution sequence described herein.

In one embodiment, in a way that can reduce the wiring requirements within a configurable unit, configuration and status registers holding unit files to be loaded in a configuration load process or unloaded in a configuration unload process in a component are connected in a serial chain and can be loaded through a process of shifting bits through the serial chain. In some embodiments, there may be more than one serial chain arranged in parallel or in series. When a configurable unit receives, for example, 128 bits of configuration data from the master AGCU in one bus cycle, the configurable unit shifts this data through its serial chain at the rate of 1 bit per cycle, where shifter cycles can run at the same rate as the bus cycle. It will take 128 shifter cycles for a configurable unit to load 128 configuration bits with the 128 bits of data received over the vector interface. The 128 bits of configuration data are referred to as a chunk. A configurable unit can require multiple chunks of data to load all its configuration bits.

The configurable units interface with the memory through multiple memory interfaces (150, FIG. 1). Each of the memory interfaces can be accessed using several AGCUs. Each AGCU contains a reconfigurable scalar datapath to generate requests for the off-chip memory. Each AGCU contains FIFOs (first-in-first-out buffers for organizing data) to buffer outgoing commands, data, and incoming responses from the off-chip memory.

The address generators AGs in the AGCUs can generate memory commands that are either dense or sparse. Dense requests can be used to bulk transfer contiguous off-chip memory regions and can be used to read or write chunks of data from/to configurable units in the array of configurable units. Dense requests can be converted to multiple off-chip memory burst requests by the coalescing unit (CU) in the AGCUs. Sparse requests can enqueue a stream of addresses into the coalescing unit. The coalescing unit uses a coalescing cache to maintain metadata on issued off-chip memory requests and combines sparse addresses that belong to the same off-chip memory request to minimize the number of issued off-chip memory requests.

FIG. 4 is a block diagram illustrating an example configurable unit 400, such as a Pattern Compute Unit (PCU). A configurable unit can interface with the scalar, vector, and control buses, in this example using three corresponding sets of inputs and outputs: scalar inputs/outputs, vector inputs/outputs, and control inputs/outputs. Scalar IOs can be used to communicate single words of data (e.g. 32 bits). Vector IOs can be used to communicate chunks of data (e.g. 128 bits), in cases such as receiving configuration data in a unit configuration load process and transmitting and receiving data during operation after configuration across a long pipeline between multiple PCUs. Control IOs can be used to communicate signals on control lines such as the start or end of execution of a configurable unit. Control inputs are received by control block 470, and control outputs are provided by the control block 470.

Each vector input is buffered in this example using a vector FIFO in a vector FIFO block 460 which can include one or more vector FIFOs. Likewise in this example, each scalar input is buffered using a scalar FIFO 450. Using input FIFOs decouples timing between data producers and consumers and simplifies inter-configurable-unit control logic by making it robust to input delay mismatches.

A configurable unit includes multiple reconfigurable datapaths in block 480. A datapath in a configurable unit can be organized as a multi-stage (Stage 1 . . . Stage N), reconfigurable SIMD (Single Instruction, Multiple Data) pipeline. The chunks of data pushed into the configuration serial chain in a configurable unit include configuration data for each stage of each datapath in the configurable unit. The configuration serial chain in the configuration data store 420 is connected to the multiple datapaths in block 480 via line 421.

A configurable datapath organized as a multi-stage pipeline can include multiple functional units (e.g. 481, 482, 483; 484, 485, 486) at respective stages. A special functional unit SFU (e.g. 483, 486) in a configurable datapath can include a configurable module 487 that comprises sigmoid circuits and other specialized computational circuits, the combinations of which can be optimized for particular implementations. In one embodiment, a special functional unit can be at the last stage of a multi-stage pipeline and can be configured to receive an input line X from a functional unit (e.g. 482, 486) at a previous stage in a multi-stage pipeline. In some embodiments, a configurable unit like a PCU can include many sigmoid circuits, or many special functional units which are configured for use in a particular graph using configuration data.

Configurable units in the array of configurable units include configuration data stores 420 (e.g. serial chains) to store unit files comprising a plurality of chunks (or sub-files of other sizes) of configuration data particular to the corresponding configurable units. Configurable units in the array of configurable units each include unit configuration load logic 440 connected to the configuration data store 420 via line 422, to execute a unit configuration load process. The unit configuration load process includes receiving, via the bus system (e.g. the vector inputs), chunks of a unit file particular to the configurable unit and loading the received chunks into the configuration data store 420 of the configurable unit. The unit file loaded into the configuration data store 420 can include configuration data, including opcodes and routing configuration, for circuits implementing a matrix multiply as described with reference to FIGS. 6-12.

The configuration data stores in configurable units in the plurality of configurable units in this example comprise serial chains of latches, where the latches store bits that control configuration of the resources in the configurable unit. A serial chain in a configuration data store can include a shift register chain for configuration data and a second shift register chain for state information and counter values connected in series.

Input configuration data 410 can be provided to a vector FIFO as vector inputs, and then be transferred to the configuration data store 420. Output configuration data 430 can be unloaded from the configuration data store 420 using the vector outputs.

The CGRA uses a daisy-chained completion bus to indicate when a load/unload command has been completed. The master AGCU transmits the program load and unload commands to configurable units in the array of configurable units over a daisy-chained command bus. As shown in the example of FIG. 4, a daisy-chained completion bus 491 and a daisy-chained command bus 492 are connected to daisy-chain logic 493, which communicates with the unit configuration load logic 440. The daisy-chain logic 493 can include load complete status logic, as described below. The daisy-chained completion bus is further described below. Other topologies for the command and completion buses are clearly possible but not described here.

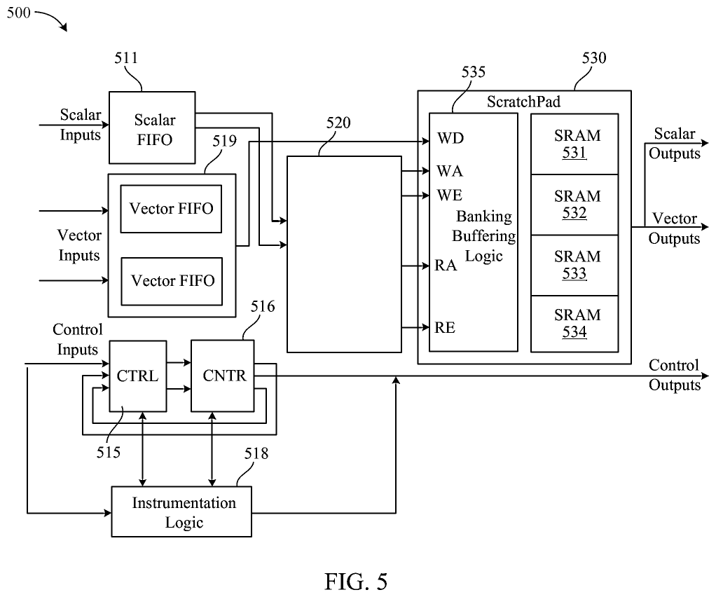

FIG. 5 is a block diagram illustrating an example configurable pattern memory unit (PMU) including an instrumentation logic unit. A PMU can contain scratchpad memory 530 coupled with a reconfigurable scalar data path 520 intended for address calculation (RA, WA) and control (WE, RE) of the scratchpad memory 530, along with the bus interfaces used in the PCU (FIG. 18). PMUs can be used to distribute on-chip memory throughout the array of reconfigurable units. In one embodiment, address calculation within the memory in the PMUs is performed on the PMU datapath, while the core computation is performed within the PCU.

The bus interfaces can include scalar inputs, vector inputs, scalar outputs and vector outputs, usable to provide write data (WD). The data path can be organized as a multi-stage reconfigurable pipeline, including stages of functional units (FUs) and associated pipeline registers (PRs) that register inputs and outputs of the functional units. PMUs can be used to store distributed on-chip memory throughout the array of reconfigurable units.

A scratchpad is built with multiple SRAM banks (e.g., 531, 532, 533, 534). Banking and buffering logic 535 for the SRAM banks in the scratchpad can be configured to operate in several banking modes to support various access patterns. A computation unit as described herein can include a lookup table stored in the scratchpad memory 530, from a configuration file or from other sources. In a computation unit as described herein, the scalar data path 520 can translate a section of a raw input value I for addressing lookup tables implementing a function f(I), into the addressing format utilized by the SRAM scratchpad memory 530, adding appropriate offsets and so on, to read the entries of the lookup table stored in the scratchpad memory 530 using the sections of the input value I. Each PMU can include write address calculation logic and read address calculation logic that provide write address WA, write enable WE, read address RA and read enable RE to the banking buffering logic 535. Based on the state of the local FIFOs 511 and 519 and external control inputs, the control block 515 can be configured to trigger the write address computation, read address computation, or both, by enabling the appropriate counters 516. A programmable counter chain 516 (Control Inputs, Control Outputs) and control block 515 can trigger PMU execution.

Instrumentation logic 518 is included in this example of a configurable unit. The instrumentation logic 518 can be part of the control block 515 or implemented as a separate block on the device. The instrumentation logic 518 is coupled to the control inputs and to the control outputs. Also, the instrumentation logic 518 is coupled to the control block 515 and the counter chain 516, for exchanging status signals and control signals in support of a control barrier network configured as discussed above.

This is one simplified example of a configuration of a configurable processor for implementing a computation unit as described herein. The configurable processor can be configured in other ways to implement a computation unit. Other types of configurable processors can implement the computation unit in other ways. Also, the computation unit can be implemented using dedicated logic in some examples, or a combination of dedicated logic and instruction-controlled processors.

FIG. 6A shows one example of matrix partitioning 600 in accordance with the matrix multiplication methods disclosed herein. As depicted, the M rows of an input matrix A and a result matrix R may be partitioned into sets of rows and the N columns of an input matrix B and the result matrix R may be partitioned into sets of columns. A compute unit (e.g., a PCU) may be assigned to each submatrix of result matrix R. Each compute unit is only required to have access to the rows of input matrix A and the columns of input matrix B that correspond to that submatrix. Consequently, each submatrix of the result matrix R may be assigned to a compute unit that is provided with access to the rows of input matrix A and the columns of input matrix B corresponding to the submatrix.

FIG. 6B shows pseudo code 610 for one example of submatrix multiplication suitable for a grid computing environment. The depicted subroutine iterates over selected rows of input matrix A (matA) and selected columns of input matrix B (matB) and computes an inner product of each combination of rows and columns to produce a submatrix of the result matrix R corresponding to the selected rows and columns. The inner product is computed (accumulated) by iterating over the length K of the respective rows and columns. The depicted pseudo code assumes the result matrix R is initialized to all zeros before the subroutine is called. One of skill in the art will appreciate that the input matrix A and/or the input matrix B need only contain the relevant rows and columns respectively rather than the entire matrices. In such cases, the depicted indexing of matA and matB (via the i and j variables) or the row and column extent variables (firstRow, lastRow, firstCol and lastCol) could be adjusted appropriately.

FIG. 6C is a block diagram of one example of a matrix multiplication configuration system 620 suitable for a reconfigurable grid computing environment. As depicted, the matrix multiplication configuration system 620 includes an assignment module 625, a memory unit configuration module 630, a compute unit configuration module 635, an RDU control module 640, and one or more RDUs 650 comprising a communication fabric 660, memory units 670 and compute units 680. The matrix multiplication configuration system 620 enables configuring memory units and compute units in a reconfigurable grid computing environment for matrix multiplication.

The assignment module 625 may determine which (logical) compute units will be involved in a matrix multiplication operation (e.g., for a tensor) and the (logical) memory units that will be required to support that operation. For example, the matrix multiplication operation may multiply matrices A and B and produce a result matrix R. The assignment module 625 may determine the number of compute units needed and assign a submatrix of R to each compute unit.

The memory unit configuration module 630 may generate the memory unit configuration information that enables one or more source memory units to provide the matrix A and matrix B data to the compute units. The compute unit configuration module 635 may generate the compute unit configuration information that enables each compute to produce their assigned submatrix and send the submatrix to one or more desired memory units.

The RDU control module 640 may communicate the memory unit configuration information and the compute unit configuration information to the RDU and initiate data flow in the computing grid to produce the result matrix R within the desired memory units. The communication fabric 660 may enable communication between the RDU control module 640 and memory units 670 and compute units 680 within the RDU(s) 650.

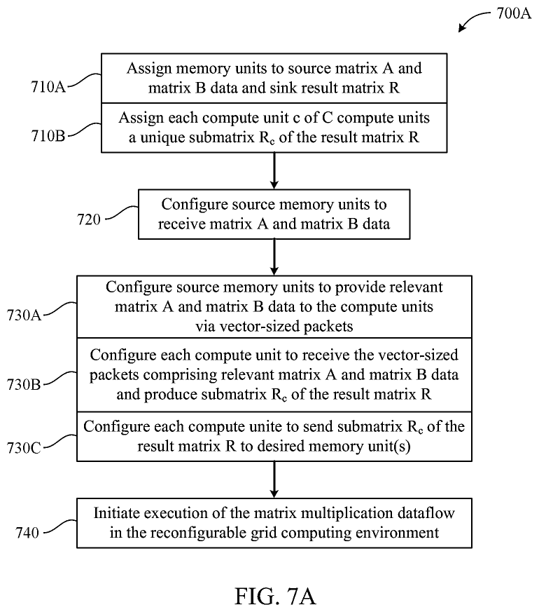

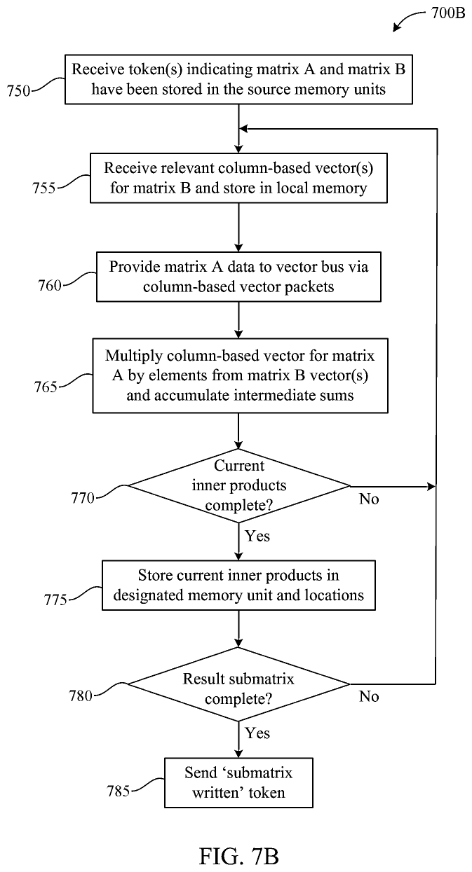

FIG. 7A is a flowchart of one example of a matrix multiplication invocation method 700A suitable for a reconfigurable grid computing environment. As depicted, the matrix multiplication method 700A includes assigning (710A) source memory units, assigning (710B) compute units, configuring (720) the source memory units to receive data, configuring (730A) the source memory units to provide data, configuring (730B) each compute unit to compute a submatrix, configuring (730C) each compute unit to send the computed submatrix to a desired memory unit and initiating (740) execution of the matrix multiplication dataflow. The matrix multiplication invocation method 700A sets up memory units and compute units in a reconfigurable grid computing environment for matrix multiplication and enables execution of the matrix multiplication on the compute units.

Assigning (710A) source memory units may include assigning one or more memory units (e.g., PMUs) each to source matrix A, source matrix B data and sink result matrix R respectively during the matrix multiplication dataflow process.

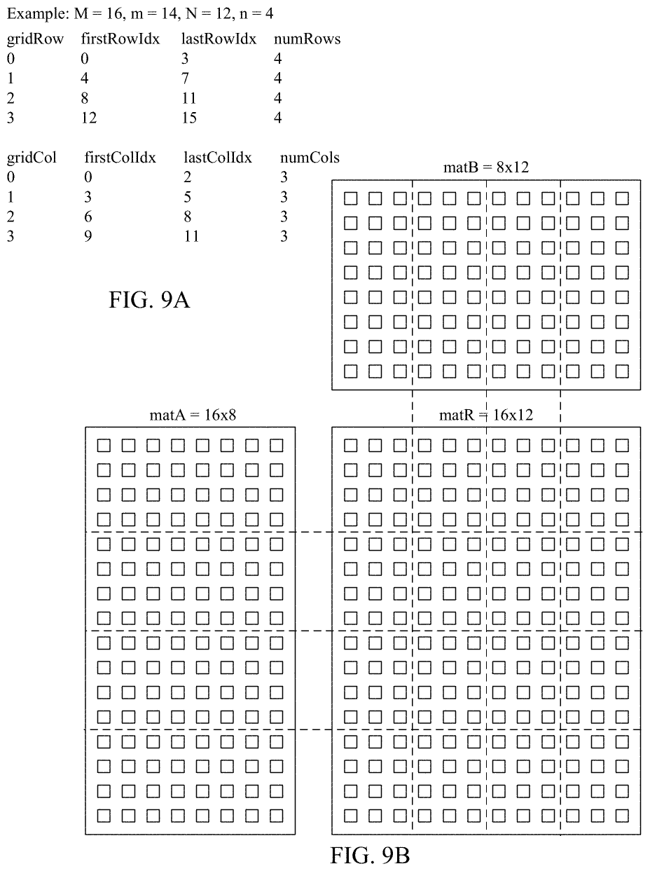

Assigning (710B) compute units may include assigning each compute unit c of C compute units a unique submatrix R_{c} of the result matrix R to compute. The number of compute units C may be determined by partitioning the M rows of the source matrix A (and the result matrix R) into m sets of rows and the N columns of the source matrix B (and the result matrix R) into n sets of columns. Partitioning into m sets of rows and n sets of columns will yield C=m·n submatrices for the result matrix R. Each submatrix can be assigned to a different compute unit. In one embodiment, an m by n grid of compute units is allocated to the matrix multiplication dataflow. See FIGS. 9-12 and associated descriptions for additional details.

Configuring (720) the source memory units to receive data may include programming one or more address generation units or specifying one or more packet sequence IDs for packets that the source memory unit(s) should store within their scratchpad memory.

Configuring (730A) the source memory units to provide data may also include programming one or more address generation units or specifying one or more packet sequence IDs for packets that the source memory unit(s) should source from their scratchpad memory.

Configuring (730B) each compute unit to compute a submatrix may include providing configuration info that specifies the operations that should be executed by the arithmetic units within a compute unit.

Configuring (730C) each compute unit to send the computed submatrix to a desired memory unit may include specifying one or more packet sequence IDs for packets that are to be sent to the desired memory unit.

Initiating (740) execution of the matrix multiplication dataflow may occur automatically in response to the source memory units receiving the required input data. For example, the matrix A and matrix B input data may be pushed to the source memory units by a previous operation conducted in the reconfigurable grid computing environment. The previous operation could be a compute operation or an I/O operation that pushes matrix A and matrix B into the appropriate source memory units.

FIG. 7B is a flowchart of one example of a submatrix multiplication execution method 700B suitable for a reconfigurable grid computing environment. As depicted, the submatrix multiplication execution method 700B includes receiving (750) one or more tokens, receiving and storing (755) one or more column-based vectors for matrix B, receiving and providing (760) a column-based vector for matrix A, multiplying and accumulating (765) a current set of intermediate sums, determining (770) whether the current inner products are complete, storing (775) the current inner products, determining (780) whether the result submatrix is complete and sending (785) a token. The submatrix multiplication execution method may be conducted by many compute units in parallel and thereby produce an entire result matrix for a matrix multiplication operation in a reconfigurable grid computing environment.

Receiving (750) one or more tokens may include receiving one or more tokens indicating matrix A and matrix B have been stored in the assigned source memory units. The tokens may be provided by one or more memory units that receive the matrix A or matrix B data, or by a previous operation conducted in a grid computing environment as a prerequisite to conducting method 700B on the matrix A and matrix B data. Receiving and storing (755) one or more column-based vectors for matrix B may include receiving one or more relevant column-based vector(s) for matrix B from a memory unit and storing the vector(s) in local memory. In one embodiment, the local memory comprises one or more queues.

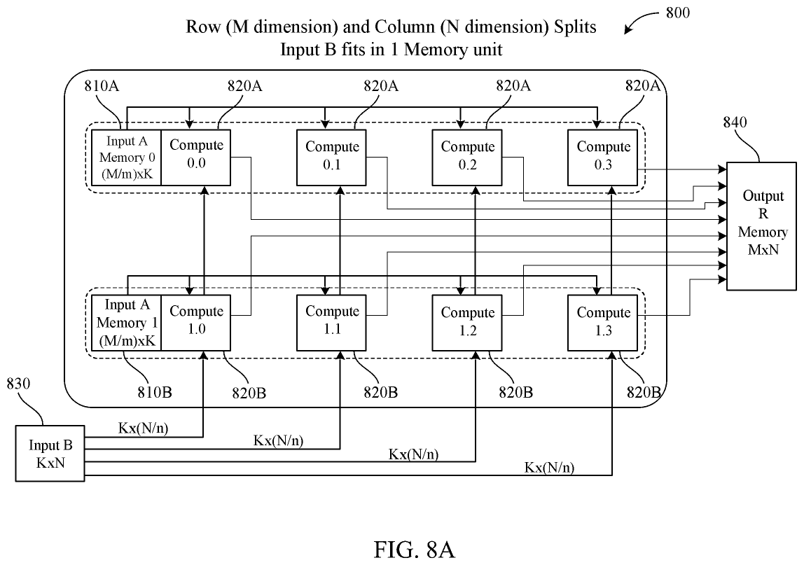

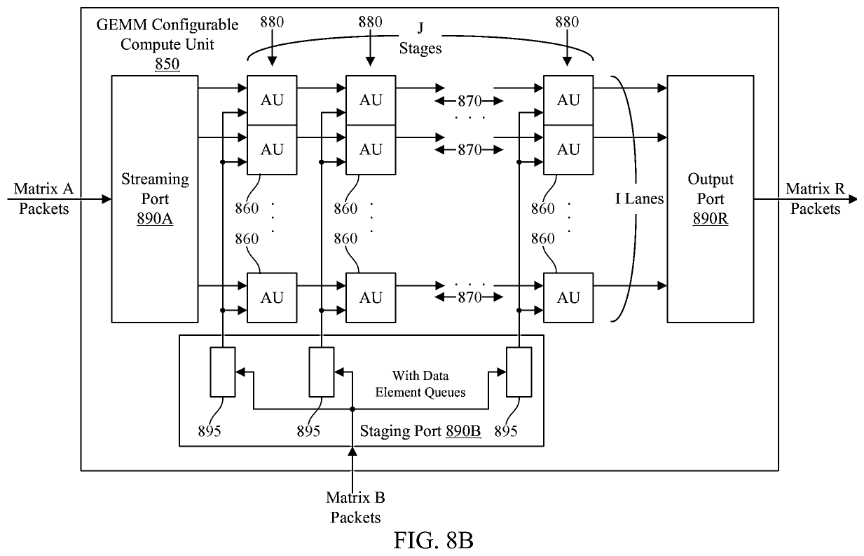

Receiving and providing (760) matrix A data may include providing a column-based vector packets for matrix A received from a memory unit to a vector bus that is connected to an array of arithmetic units internally arranged with multiple stages and multiple lanes (see, for example, FIG. 8B and the associated description). Each arithmetic unit may be capable of conducting a multiply and accumulate operation. Each element of the column-based matrix A vector packets may be provided to a different lane of the compute units and sequentially to each of the stages within that lane.

Multiplying and accumulating (765) the current intermediate sums may include each stage multiplying a sequence of matrix B elements provided by local memory (each stage corresponding to a different matrix B column) with a sequence of matrix A vectors (corresponding to particular rows of matrix A) provided on the vector bus. Each arithmetic unit may sequentially conduct multiply and accumulate operations and thereby compute intermediate sums corresponding to a particular entry in the result matrix R. Consequently, with I lanes and J stages, I×J intermediate sums may be computed for the result matrix R.

One of skill in the art will appreciate that the bandwidth requirement for matrix A data and matrix B data may not be equal. Since the number of lanes I and stages J may be highly imbalanced (e.g., a 5 to 1 lane to stage ratio) the number rows I and columns J for which an inner product can be concurrently computed will also be imbalanced. In such situations, the assigned rows of matrix A may need to be streamed through the array of arithmetic units multiple times in order to process all of the assigned columns of matrix B (or vice versa if there are more stages than lanes). Consequently, it may be advantageous to have the memory unit(s) for matrix A be more tightly coupled to the compute units than the memory for matrix B (or vice versa if there are more stages than lanes). For purposes of clarity, the depicted ordering and description of the method 700B (as well as other Figures) assumes there are more lanes than stages and that the memory unit(s) for the matrix A data is/are tightly coupled to the compute unit.

Determining (770) whether the current inner products are complete may include determining whether all elements of the matrix A rows and matrix B columns currently being processed have been processed. If not all elements of the current matrix A rows and matrix B columns have been processed, the method loops to step 755. If all elements of the current matrix A rows and matrix B columns have been processed the method proceeds by storing (775) the current inner products.

Storing (775) the current inner products may include storing the accumulated sums in a memory unit assigned to store the submatrix computed by method 700B. Determining (780) whether the result submatrix is complete may include decrementing or incrementing a counter, such as row or column counter, that indicates the progress of the submatrix multiplication process. If the result submatrix is not complete, the method loops to step 755. If the result submatrix is complete the method proceeds by sending (785) a token. Sending (785) a token may include a memory unit or a compute unit sending a token indicating that the assigned result submatrix has been computed and written to the assigned memory unit.

FIG. 8A shows one example of distributing matrices in an example grid computing environment. As depicted, matrix A data may be distributed to memory units 810 that are each (tightly) coupled to, and dedicated to, a row of compute units 820. In the depicted example, memory unit 810A is coupled to (a first row of) compute units 820A, memory unit 810B is coupled to (a second row of) compute units 820B and M/m (i.e., half of the) rows of matrix A are provided to each row of compute units 820. In contrast, matrix B data may be narrowcast, as needed, to a specific set of compute units. For example, all of the compute units in a column of a (virtual or physical) computing grid may be provided with specific (e.g., N/n) columns from matrix B that correspond to their assigned submatrix. The specific columns may be sent (i.e., narrowcast) from one or more memory units 830 via a set of packets that are intended only for those compute units. Consequently, in the described embodiment each of the compute units in the grid need only be provided with and receive those packets that contain those columns of matrix B that correspond to their assigned submatrix.

In the depicted embodiment, matrix B is stored in a single memory unit 830 and matrix R is stored in a single (grid connected) memory unit 840. However, matrix B and/or matrix R, may be spread across multiple memory units 830/840. In those embodiments, an interposer memory unit (not shown) may be used to retrieve matrix B data and distribute the data to the appropriate compute units as needed. Similarly, an interposer memory unit (not shown) may be used to receive matrix R data from the compute units and distribute the data to the appropriate memory units that are selected to (at least temporarily) store matrix R.

One of skill in the art will appreciate that the bandwidth requirement for the matrix A data may be higher for the submatrix multiplication execution method 700B depicted in FIG. 7B due to the rate at which vector-sized data packets for matrix A (e.g., one packet per cycle) are streamed to the vector bus. In contrast, the bandwidth requirement for matrix B (e.g., one matrix value per cycle) may be much lower. Consequently, as shown in FIG. 8A, matrix A data is preferably partitioned by rows into separate memory units for each row of compute units. In contrast, matrix B data may be broadcast to all compute units or narrowcast to each column of computes by a similar partitioning of the matrix B data by columns. However, since the bandwidth requirement for matrix B data is less than matrix A, it may not be necessary to partition the matrix B data into separate memory units and thereby use fewer memory units.

FIG. 8B is a block diagram illustrating one example of a compute unit 850 configurable for the matrix multiplications methods disclosed herein. As depicted, the compute unit 850 includes an array of arithmetic units 860 organized into I lanes 870 and J (pipelined) stages 880. The compute unit 850 also includes a set of ports 890 including a streaming port 890A that receives packets of matrix A data, a staging ports 890B that receives packets of matrix B data, and an output port 890R that provides packets of matrix R data. The compute unit 850 is one example of the PCUs 342 depicted in FIG. 3A. The compute unit 850 may be configured to efficiently execute matrix multiplication.

The streaming port 890 may be configured to sequentially stream K vector packets comprising matrix A data through the I lanes of the array of arithmetic units 860. Each of the K vector packets may comprise I column-ordered data elements corresponding to I rows of matrix A data. In one embodiment, a row connected memory unit is configured to stream the I rows of matrix A data by providing the K vector packets to the compute unit 850 and other compute units 850 on the same row of a computing grid that are assigned to the matrix multiplication task.

The staging port 890B may be configured to receive J vector packets corresponding to J columns of matrix B data and sequentially provide a data element from each of the J vector packets to a corresponding stage of the array of arithmetic units 860. The J vector packets may be received by a set of J data element queues 895 that sequentially provide one data element at a time to the arithmetic units 860 of the corresponding stage 870. In the depicted embodiment, each data element queue 895 provides one data element to every arithmetic unit of the corresponding stage 870 in a single compute cycle.

The arithmetic units 860 may be configured to repetitively conduct multiply-accumulate operations using a data element from the streaming port (i.e., a row of matrix A) and a data element from the staging port (i.e., a column of matrix B). In the depicted embodiment, K multiply accumulate operations may be conducted by each arithmetic unit to compute the inner product of a row of matrix A and a column of matrix B that are each of length K.

One of skill in the art will appreciate that each arithmetic unit concurrently computes an inner product for a different row and column combination of the result matrix R. Consequently, the inner product of I rows and J columns may be concurrently computed by the compute unit 850 to produce I rows and J columns of the result submatrix assigned to the compute unit 850. When the K multiply accumulate operations are complete, the computed inner products may be streamed to one or more assigned memory units via the output port 890R. The process may be repeated until all rows (e.g., M/m) and columns (e.g., N/n) of the assigned submatrix have been computed by the compute unit 850.

One of skill in the art will appreciate that the stages 880 of the array of arithmetic units 860 may act as data registers for the lanes 880 while the matrix A data is streamed through the stages of the compute unit and the multiply accumulate operations are conducted. When the multiply accumulate operations are complete (for the current rows of matrix A and columns of matrix B) the computed sums (i.e., inner products) from the internal accumulators of the arithmetic units (not shown) may be provided to the outputs of the arithmetic units and then advanced through the remaining stages to the output port 890R and then to one or more memory units assigned to store the result submatrix Rc.

FIG. 9A and FIG. 9B show one example of uniform partitioning of matrices used in matrix multiplication. As shown in FIG. 9A, the number of rows M in the input matrix A and the result matrix R are selected (or happen to be) a multiple of the number of rows m in the computing grid. Similarly, the number of columns N in the input matrix B and the result matrix R are selected (or happen to be) a multiple of the number of columns n in the computing grid. Conversely, the number of rows m and columns n in the computing grid can be selected to be a submultiple of M and N respectively. In such situations, the number of rows (e.g., M/m) and columns (e.g., N/n) assigned to each result submatrix and the computing units will be identical (i.e., uniform). Having a uniform processing load may increase the utilization and throughput of the compute units.

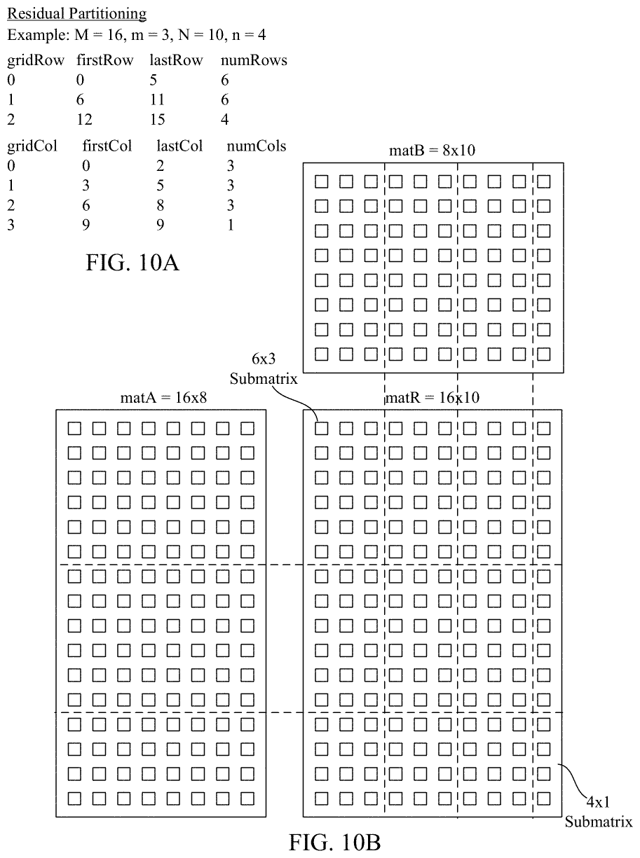

In some situations, however, it may not be desirable or practical to have the number of rows and columns in the computing grid be exact submultiples of the rows M and the columns N of the result matrix. FIG. 10A and FIG. 10B show one example of residual partitioning of matrices used in matrix multiplication. As depicted, the last row of the computing grid may be assigned the residual rows of matrices A and R. The rest of the rows of the computing grid may be assigned a number of rows equal to the ceiling of the rows M of the result matrix divided by the rows m of the computing grid. Similarly, the last column of the computing grid may be assigned the residual columns of matrices B and R. The rest of the columns of the computing grid may be assigned a number of columns equal to the ceiling of the columns N of the result matrix R divided by the columns n of the computing grid.

One drawback to the residual partitioning approach depicted in FIG. 10A and FIG. 10B is that the computing load for the compute units that are assigned the residual rows and columns may be significantly less than the rest of the compute units. Consequently, those compute units may be underutilized. In the depicted example, most compute units are assigned 6 rows and 3 columns. However, the compute unit that is assigned the lower right submatrix is only assigned 4 rows and one column. Consequently, the computational load on that compute unit would be approximately 22 percent of the computational load on most of the compute units.

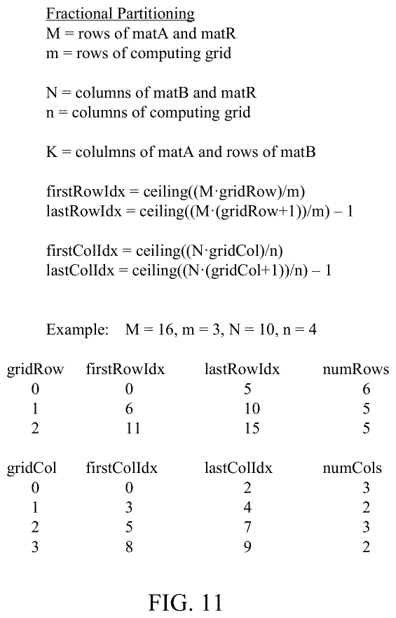

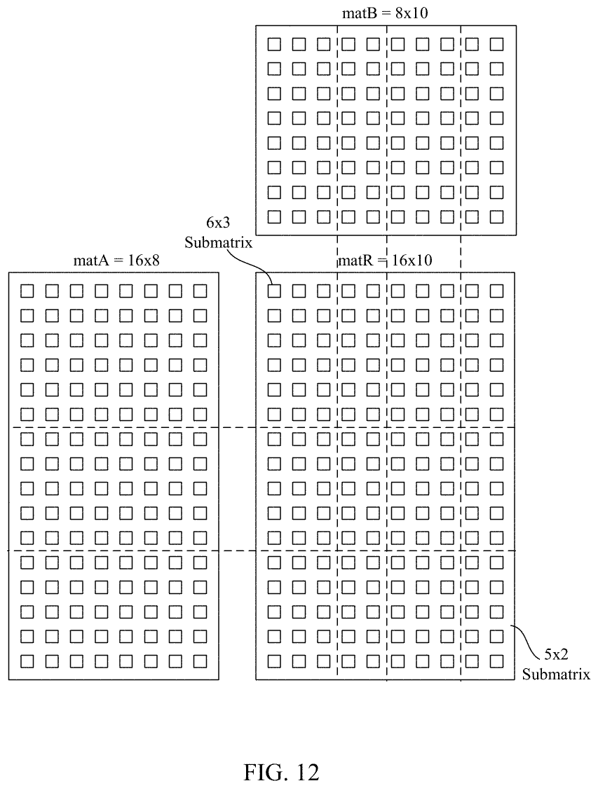

FIG. 11 and FIG. 12 show one example of fractional partitioning of matrices used in matrix multiplication. As depicted, the extent variables (e.g., firstRowIdx, lastRowIdx, firstColIdx and lastColIdx) may be computed such that the variation in the number of assigned rows and columns is limited to one. Specifically, the number of rows is either the floor or ceiling of the M divided by m (i.e., the number of rows M of input matrix A and result matrix R divided by the number of rows m of the computing grid). Similarly, the number of columns is either the floor or ceiling of N divided by n (i.e., the number of columns N of input matrix B and result matrix R divided by the number of columns n of the computing grid). By partitioning in the described manner, the variation in computational load may be significantly reduced. For example, in the depicted example the largest submatrix has 6 rows and 3 columns while the smallest submatrix has 5 rows and 2 columns. Consequently, the smallest computational load is approximately 56 percent of the largest computational load rather than. One of skill in the art will appreciated that with larger matrices than the depicted examples, the percentage variation in computational load would be much less.

The embodiments disclosed herein include a system for multiplying matrices A and B and producing a result matrix R in a coarse-grained computing grid, the system comprising:
a memory unit configuration module for configuring one or more source memory units to provide relevant matrix A data and matrix B data to the C compute units via a plurality of packets
a compute unit configuration module for configuring each compute unit c to
   produce the unique submatrix R_{c}
   send the unique submatrix R_{c} to one or more desired memory units
an RDU control module for initiating data flow in the computing grid to produce the result matrix R within the desired memory units
wherein providing matrix B data to the C compute units comprises narrowcasting packets to each column of compute units in the 2D computing grid, wherein the narrow-casted packets comprise matrix B data corresponding to the column of compute units

Optional features for the above system include:
wherein the compute unit configuration module configures each compute unit to send submatrix R_{c} of the result matrix R to one or more desired memory units for the result matrix R
wherein each compute unit c of the C compute units produces the unique submatrix submatrix R_{c} by sequentially providing column-based vectors for matrix A to a vector bus and concurrently conducting a multiply accumulate operation for each data element of the column-based vectors
wherein the compute units for each row of the 2D computing grid are connected to a memory unit dedicated to that row
   wherein (the floor or ceiling of) of M/m rows of matrix A are stored in the shared memory unit for each row of the 2D computing grid
wherein the compute units of the 2D computing grid are connected to a grid connected memory unit
   wherein all columns of matrix B are stored in the grid connected memory unit
wherein the number of rows in each unique submatrix R_{c} is equal to the floor or ceiling of M/m
wherein the number of columns in each unique submatrix R_{c} is equal to the floor or ceiling of N/n
wherein a compute unit of the 2D computing grid comprises an array of arithmetic units comprising I lanes and J pipelined stages
   wherein the compute unit comprises a streaming port configurable to sequentially stream K vector packets comprising matrix A data through the I lanes of the array of arithmetic units where each vector packet of the K vector packets comprises I column-ordered data elements corresponding to I rows of matrix A data
      wherein the row connected memory unit is configurable to stream I rows of matrix A data to the vector port via the K vector packets
      wherein the compute unit comprises a staging port configurable to receive J vector packets corresponding to J columns of matrix B data and sequentially provide a data element from each of the J vector packets to a corresponding stage of the array of compute units
         wherein the data element is concurrently provided to every arithmetic unit of the corresponding stage of the array of arithmetic units
         wherein each arithmetic unit of the array of arithmetic units is configurable to repetitively conduct a multiply-accumulate operation using a data element from the streaming port and a data element from the staging port

The embodiments disclosed herein include a method for multiplying matrices A and B and producing a result matrix R in a coarse-grained computing grid, the method comprising:
assigning each compute unit c of C compute units to a unique submatrix R_{c} of a result matrix R, wherein the C compute units are arranged in a 2D computing grid comprising m rows and n columns
configuring one or more source memory units to provide relevant matrix A data and matrix B data to the C compute units via a plurality of packets
configuring each compute unit c to
   produce the unique submatrix R_{c}
   send the unique submatrix R_{c} to one or more desired memory units
initiating data flow in the computing grid to produce the result matrix R within the desired memory units
wherein providing matrix B data to the C compute units comprises narrowcasting packets to each column of compute units in the 2D computing grid, wherein the narrowcasted packets comprise matrix B data corresponding to the column of compute units

Optional features for the above method include:

configuring each compute unit to send submatrix R_{c} of the result matrix R to one or more desired memory units for the result matrix R
wherein the plurality of packets are vector-sized packets each comprising a vector of data elements that can be processed in parallel by a compute unit
wherein each compute unit c of the C compute units produces the unique submatrix submatrix R_{c} by sequentially providing column-based vectors for matrix A to a vector bus and concurrently conducting a multiply accumulate operation for each data element of the column-based vectors
wherein the compute units for each row of the 2D computing grid are connected to a memory unit dedicated to that row
   wherein (the floor or ceiling of) of M/m rows of matrix A are stored in the shared memory unit for each row of the 2D computing grid
wherein the compute units of the 2D computing grid are connected to a grid connected memory unit
   wherein all columns of matrix B are stored in the grid connected memory unit
wherein the number of rows in each unique submatrix R_{c} is equal to the floor or ceiling of M/m
wherein the number of columns in each unique submatrix R_{c} is equal to the floor or ceiling of N/n

Referring again to (at least) FIG. 4 and as will be appreciated by those of ordinary skill in the art, aspects of the various embodiments described herein may be embodied as a system, device, method, or computer program product apparatus. Accordingly, elements of the present disclosure may take the form of an entirely hardware embodiment, an entirely software embodiment (including firmware, resident software, micro-code, or the like) or an embodiment combining software and hardware aspects that may all generally be referred to herein as a “apparatus,” “circuit,” “circuitry,” “module,” “computer,” “logic,” “FPGA,” “unit,” “system,” or other terms. Furthermore, aspects of the various embodiments may take the form of a computer program product embodied in one or more computer-readable medium(s) having computer program code stored thereon. The phrases “computer program code” and “instructions” both explicitly include configuration information for a CGRA, an FPGA, or other programmable logic as well as traditional binary computer instructions, and the term “processor” explicitly includes logic in a CGRA, an FPGA, or other programmable logic configured by the configuration information in addition to a traditional processing core. Furthermore, “executed” instructions explicitly includes electronic circuitry of a CGRA, an FPGA, or other programmable logic performing the functions for which they are configured by configuration information loaded from a storage medium as well as serial or parallel execution of instructions by a traditional processing core.

Any combination of one or more computer-readable storage medium(s) may be utilized. A computer-readable storage medium may be embodied as, for example, an electronic, magnetic, optical, electromagnetic, infrared, or semiconductor system, apparatus, or device, or other like storage devices known to those of ordinary skill in the art, or any suitable combination of computer-readable storage mediums described herein. In the context of this document, a computer-readable storage medium may be any tangible medium that can contain, or store, a program and/or data for use by or in connection with an instruction execution system, apparatus, or device. Even if the data in the computer-readable storage medium requires action to maintain the storage of data, such as in a traditional semiconductor-based dynamic random-access memory, the data storage in a computer-readable storage medium can be considered to be non-transitory. A computer data transmission medium, such as a transmission line, a coaxial cable, a radio-frequency carrier, and the like, may also be able to store data, although any data storage in a data transmission medium can be said to be transitory storage. Nonetheless, a computer-readable storage medium, as the term is used herein, does not include a computer data transmission medium.

Computer program code for carrying out operations for aspects of various embodiments may be written in any combination of one or more programming languages, including object-oriented programming languages such as Java, Python, C++, or the like, conventional procedural programming languages, such as the “C” programming language or similar programming languages, or low-level computer languages, such as assembly language or microcode. In addition, the computer program code may be written in VHDL, Verilog, or another hardware description language to generate configuration instructions for an FPGA, CGRA IC, or other programmable logic. The computer program code if converted into an executable form and loaded onto a computer, FPGA, CGRA IC, or other programmable apparatus, produces a computer implemented method. The instructions which execute on the computer, FPGA, CGRA IC, or other programmable apparatus may provide the mechanism for implementing some or all of the functions/acts specified in the flowchart and/or block diagram block or blocks. In accordance with various implementations, the computer program code may execute entirely on the user's device, partly on the user's device and partly on a remote device, or entirely on the remote device, such as a cloud-based server. In the latter scenario, the remote device may be connected to the user's device through any type of network, including a local area network (LAN) or a wide area network (WAN), or the connection may be made to an external computer (for example, through the Internet using an Internet Service Provider). The computer program code stored in/on (i.e. embodied therewith) the non-transitory computer-readable medium produces an article of manufacture.

The computer program code, if executed by a processor, causes physical changes in the electronic devices of the processor which change the physical flow of electrons through the devices. This alters the connections between devices which changes the functionality of the circuit. For example, if two transistors in a processor are wired to perform a multiplexing operation under control of the computer program code, if a first computer instruction is executed, electrons from a first source flow through the first transistor to a destination, but if a different computer instruction is executed, electrons from the first source are blocked from reaching the destination, but electrons from a second source are allowed to flow through the second transistor to the destination. So, a processor programmed to perform a task is transformed from what the processor was before being programmed to perform that task, much like a physical plumbing system with different valves can be controlled to change the physical flow of a fluid.

We claim as follows:

1. A system for multiplying matrices A and B and producing a result matrix R in a coarse-grained computing grid, the system comprising:
an RDU comprising a computing grid, the computing grid comprising C compute units arranged in a 2D grid comprising m logical rows and n logical columns;
an assignment module for assigning each compute unit c of C compute units to a unique submatrix R_{c} of a result matrix R comprising M rows and N columns;
a memory unit configuration module for generating memory unit configuration information that enables one or more source memory units to provide relevant matrix A data and matrix B data to the C compute units via a plurality of packets;
a compute unit configuration module for generating compute unit configuration information that enables each compute unit c to produce the unique submatrix R_{c} and send the unique submatrix R_{c} to one or more desired memory units;
an RDU control module for communicating the memory unit configuration information and the compute unit configuration information to the RDU and initiating data flow in the computing grid to produce the result matrix R within the desired memory units; and
wherein providing matrix B data to the C compute units comprises narrowcasting packets to each column of compute units in the computing grid, wherein the narrow-casted packets comprise matrix B data corresponding to the column of compute units.

2. The system of claim 1, wherein the compute unit configuration module configures each compute unit to send submatrix R_{c} of the result matrix R to one or more desired memory units for the result matrix R.

3. The system of claim 1, wherein each compute unit c of the C compute units produces the unique submatrix R_{c} by sequentially providing column-based vectors for matrix A to a vector bus and concurrently conducting a multiply accumulate operation for each data element of the column-based vectors.

4. The system of claim 1, wherein the compute units for each row of the computing grid are connected to a memory unit dedicated to that row of the computing grid.

5. The system of claim 4, wherein all rows of matrix A are stored in the memory unit dedicated to that row of the computing grid.

6. The system of claim 1, wherein the compute units of the computing grid are connected to a grid connected memory unit that provides the narrow-casted packets.

7. The system of claim 1, wherein a compute unit of the 2D computing grid comprises an array of arithmetic units comprising I lanes and J pipelined stages.

8. The system of claim 7, wherein the compute unit comprises a streaming port configurable to sequentially stream K vector packets comprising matrix A data through the I lanes of the array of arithmetic units where each vector packet of the K vector packets comprises I column-ordered data elements corresponding to I rows of matrix A data.

9. The system of claim 8, wherein a row connected memory unit is configurable to stream the I rows of matrix A data to the vector port via the K vector packets.

10. The system of claim 8, wherein the compute unit comprises a staging port configurable to receive J vector packets corresponding to J columns of matrix B data and sequentially provide a data element from each of the J vector packets to a corresponding stage of the array of compute units.

11. The system of claim 10, wherein the data element is concurrently provided to every arithmetic unit of the corresponding stage of the array of arithmetic units.

12. The system of claim 10, wherein each arithmetic unit of the array of arithmetic units is configurable to repetitively conduct a multiply-accumulate operation using a data element from the streaming port and a data element from the staging port.

13. A method for multiplying matrices A and B and producing a result matrix R in a coarse-grained computing grid, the method comprising:
assigning each compute unit c of C compute units to a unique submatrix R_{c} of a result matrix R comprising M rows and N columns, wherein the C compute units are arranged in a computing grid comprising m logical rows and n logical columns;
configuring one or more source memory units to provide relevant matrix A data and matrix B data to the C compute units via a plurality of packets;
configuring each compute unit c to produce the unique submatrix R_{c} and send the unique submatrix R_{c} to one or more desired memory units;
initiating data flow in the computing grid to produce the result matrix R within the desired memory units; and
wherein providing matrix B data to the C compute units comprises narrowcasting packets to each column of compute units in the computing grid, wherein the narrow-casted packets comprise matrix B data corresponding to the column of compute units.

14. The method of claim 13, further comprising configuring each compute unit to send submatrix R_{c} of the result matrix R to one or more desired memory units for the result matrix R.

15. The method of claim 13, wherein the plurality of packets are vector-sized packets each comprising a vector of data elements that can be processed in parallel by a compute unit.

16. The method of claim 13, wherein each compute unit c of the C compute units produces the unique submatrix submatrix R_{c} by sequentially providing column-based vectors for matrix A to a vector bus and concurrently conducting a multiply accumulate operation for each data element of the column-based vectors.

17. The method of claim 13, wherein the compute units for each row of the computing grid are connected to a memory unit dedicated to that row of the computing grid.

18. The method of claim 17, wherein all rows of matrix A are stored in the memory unit dedicated to that row of the computing grid.

19. The method of claim 18, further comprising providing the narrow-casted packets via a grid connected memory unit connected to each of the compute units of the computing grid.

20. A computer readable medium having instructions encoded thereon to execute a method for multiplying matrices A and B and producing a result matrix R in a coarse-grained computing grid, the method comprising:
assigning each compute unit c of C compute units to a unique submatrix R_{c} of a result matrix R comprising M rows and N columns, wherein the C compute units are arranged in a computing grid comprising m rows and n columns;
configuring one or more source memory units to provide relevant matrix A data and matrix B data to the C compute units via a plurality of packets;
configuring each compute unit c to produce the unique submatrix R_{c} and send the unique submatrix R_{c} to one or more desired memory units;
initiating data flow in the computing grid to produce the result matrix R within the desired memory units; and
wherein providing matrix B data to the C compute units comprises narrowcasting packets to each column of compute units in the computing grid, wherein the narrow-casted packets comprise matrix B data corresponding to the column of compute units.
